(19) United States
(12) Patent Application Publication
(10) Pub. No.: US 2010/0220864 A1
(43) Pub. Date: Sep. 2, 2010

(54) LOW FREQUENCY MANAGEMENT FOR MULTICHANNEL SOUND REPRODUCTION SYSTEMS

(76) Inventors: Geoffrey Glen Martin, Vinderup (DK); Henrik Fløe Mikkelsen, Kjellerup (DK)

Correspondence Address: STITES & HARBISON PLLC, 1199 NORTH FAIRFAX STREET, SUITE 900, ALEXANDRIA, VA, 22314, US

(21) Appl. No.: 12/680,933

(22) PCT Filed: Oct. 2, 2008
(86) PCT No.: PCT/IB08/54015

§ 371 Date: Mar. 31, 2010

Related U.S. Application Data
(60) Provisional application No. 60/977,748, filed on Oct. 5, 2007.

(51) Int. Cl. H04R 5/00

(52) U.S. Cl. 381/1

(57) ABSTRACT

The present invention relates generally to sound reproduction systems and methods and more specifically to the reproduction of low-frequency signal components recorded in a Low Frequency Effects (LFE) channel. According to the invention there is provided a system comprising: n input channels (1, 2, 3) for receiving in multichannel sound signals; at least one input channel (4) for receiving a low-frequency effects (LFE) signal; n output channels (13, 14, 15) for providing signals from the system to respective transducers, such as loudspeakers (31, 32, 33); for each of said input channels (I1 2, 3) high-pass filter means (5, 6, 7) receiving a signal from said respective input channel (I, 2, 3) and providing a corresponding high-pass filtered signal (22, 23, 24) to a respective second summing means (16, 17, 18); for each of said input channels (1, 2, 3) low-pass filter means (8, 9, 10) receiving a signal from said respective input channel (1, 2, 3) and providing a corresponding low-pass filtered signal to first summing means (12); for said at least one input channel (4) for receiving a low frequency effects (LFE) signal, gain means (I I) receiving said low frequency effects (LFE) signal and providing an output signal (35) to said first summing means (12); for each of said output channels (13, 14, 15) LFE signal processing means (19, 20, 21) each receiving a signal from said first summing means (12) and each providing a processed output signal to said respective second summing means (16, 17, 18); where each of said second summing means (16, 17, 18) has an output connected to each of said output channels (13, 14, 15); whereby each of said output channels (13, 14, 15) provides processed output signals for each of said transducers, such as loudspeakers (31, 32, 33), respectively.

### TECHNICAL FIELD

The invention relates generally to sound reproduction systems and methods and more specifically to the reproduction of low frequency signal components recorded in a Low Frequency Effects (LFE) channel.

### BACKGROUND OF THE INVENTION

Existing bass management systems for multichannel playback are designed for hardware configurations that contain a number of loudspeakers that are incapable of reproducing extremely low frequency content in the program material. Consequently, the signals are divided into low frequency and high frequency components using a crossover network. The high frequency components are produced by the “main” loudspeakers, The corresponding low frequency components are typically summed with each other and with a Low Frequency Effects (LFE) channel (where applicable) and directed to a dedicated low-frequency loudspeaker termed a “subwoofer.” A simple example of such a prior art system for 5.1-channel program material is shown in FIG. 1.

FIG. 1 shows individual crossover networks for each of the full-bandwidth channels with the low frequency output of each routed to a summing bus (LFE Channel Mixing Bus). In addition, the LEE channel is typically boosted by 10 dB and added to the same summing bus, This combined signal is then routed to the subwoofer's amplifier, In cases where the main loudspeakers have matched characteristics, then the crossover characteristics will also be matched from channel to channel However, in cases where the loudspeakers are not matched (for example, when the surround loudspeakers have reduced bass handling potential), the crossover characteristics for each channel can be tailored to the requirements of the corresponding loudspeaker(s).

### SUMMARY OF THE INVENTION

The principle of the present invention is based on the fact that if each loudspeaker in a loudspeaker system comprising several loudspeakers is approximated by a sound pressure source, then the total sound pressure at a listening position is the sum of the individual sound pressures generated by each separate loudspeaker. In real situations, this approximation is increasingly correct at lower frequency bands. Therefore, at very low frequencies, if a coherent signal is provided to all loudspeakers these can be considered to act in unison as a single larger loudspeaker.

The above principle is according to the present invention used to provide a replacement for a single subwoofer. Thus, according to the invention, rather than directing the summed low-frequency channel to a single low-frequency loudspeaker for instance as in the prior art system shown in FIG. 1, it is routed back to the main loudspeakers as a signal coherent in all channels.

This re-direction would generally require that the signal on the summed low frequency channel be suitably processed before being summed back to the individual loudspeaker outputs. This processing may specifically be a gain applied to the low-frequency channel before summing back to the individual loudspeaker outputs. This gain would be dependent on at least two factors:
1. The number of loudspeakers in the configuration. The more loudspeakers there are in the system, the lower the gain of the low-frequency channel added to it.
2. The bass power-handling capabilities of the loudspeaker connected to a given output channel. There may be cases where the loudspeaker is incapable of reliably reproducing even moderate levels at low frequencies. In this situation, the gain of the low frequency channel routed to that particular loudspeaker should be reduced accordingly. If one or more of the loudspeakers suffers from a limited capability of reproducing low frequencies at higher levels, this problem may, however, alternatively be solved by introducing a frequency-dependent processing of the signal on the summed low frequency channel before summing the processed signal back to individual loudspeaker outputs. Furthermore a suitable compressor limiter may be introduced, possibly in combination with gain/attenuation means and a frequency-dependent processing means (filter or equalizer) in order to avoid the risk of overloading the individual loudspeakers.

Applying the principles of the present invention, the use of a subwoofer can thus be avoided without the risk of overloading the main loudspeakers (output channels 1 through n) with powerful low frequency signal components.

According to a first aspect of the present invention there is provided a system for the reproduction of multichannel sound signals comprising:
a) n input channels for receiving multichannel sound signals;
b) at least one input channel for receiving a low frequency effects (LFE) signal;
c) n output channels for providing signals from the system to respective transducers, such as loudspeakers;
d) for each of said input channels, high-pass filter means receiving a signal from said respective input channel and providing a corresponding high-pass filtered signal to a respective second summing means;
e) for each of said input channels, low-pass filter means receiving a signal from said respective input channel and providing a corresponding low-pass filtered signal to first summing means;
f) for said at least one input channel for receiving a low frequency effects (LFE) signal, gain means receiving said low frequency effects (LFE) signal and providing an output signal to said first summing means;
g) for each of said output channels LFE signal processing means, each receiving a signal from said first summing means and each providing a processed output signal to said respective second summing means;
h) each of said second summing means having an output connected to each of said output channels;
   whereby each of said output channels provides processed output signals for each of said transducers, such as loudspeakers, respectively.

According to one specific embodiment of a system according to the invention, the LFE signals processing means provides either frequency-independent gain or frequency-independent attenuation of said signal received from said first summing means.

According to another specific embodiment of a system according to the invention, the LFE signal processing means is characterized by a frequency-dependent transfer function Gᵢ(f).

According to still another specific embodiment of a system according to the invention, the LFE signal processing means comprises a limiter for limiting powerful signal components present in the first summing means.

It is understood that any combination of the above mentioned frequency-independent gain/attenuation, frequency-dependent transfer function and limiter can also be applied according to the invention.

According to a second aspect of the present invention there is provided a method for the reproduction of multichannel sound signals consisting of n input signals, at least one low frequency effects (LFE) signal and n output signals, where the method comprises:
i. for each of said input signals providing a high-pass filtered signal;
ii. for each of said input signals providing a low-pass filtered signal;
iii. for each of said at least one low frequency effects (LFE) signals processing these respective signals thereby providing respective amplified or attenuated low frequency effects (LFE) output signals, where said amplification or attenuation may specifically be equal to 1 ( 0dB);
iv. summing in first summing means each of said low-pass filtered signals and said at least one amplified or attenuated low frequency effects (LFE) output signals, whereby a summed signal is obtained;
v. providing each of said n output signals, such that each respective of the n output signals is obtained as a sum of a respective of said high-pass filtered signal and a processed version of said summed signal, where said processing is characterized by a transfer function Gi(f), wherein i designates the particular output signal and where Gi(f) is either a frequency-independent gain or a frequency-independent attenuation, which gain or attenuation specifically can be equal to unity, or where Gi(f) is a frequency-dependent transfer function and where Gi(f) may additionally comprise limiting of the level of said summed signal.

### BRIEF DESCRIPTION OF THE DRAWINGS

The invention will be better understood with reference to the following detailed description of an embodiment of the invention in conjunction with the figures of the drawing, where:

FIG. 1 shows a typical implementation of a prior art bass management system for multichannel media, wherein the vertical line indicates a summing bus where all signals arriving from the low-pass filters connected to each of the respective input channels are added; and

FIG. 2 shows an embodiment of the system according to the present invention

### DETAILED DESCRIPTION OF THE INVENTION

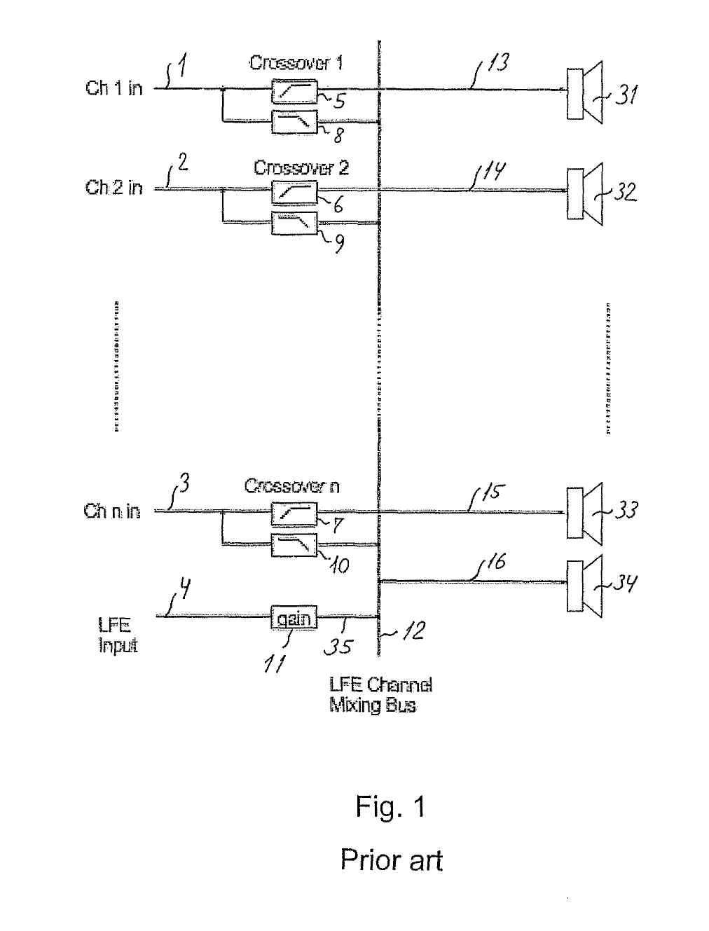

Referring to FIG. 1 there is shown a prior art bass management system for multichannel media comprising n input channels 1, 2 and 3, and a dedicated input channel 4 specifically used to input a low frequency effects (LFE) signal to the system. The system furthermore comprises n output channels 13, 14 and 15 and a dedicated output channel 16 providing an output signal for a low frequency loudspeaker unit (a subwoofer). The prior art system shown in FIG. 1 furthermore comprises n crossover arrangements, each comprising a high-pass filter 5, 6, 7 and a low-pass filter 8, 9, 10. Each respective high-pass filter is coupled to the corresponding input channel and provides a high-passed signal to the respective output channel. Consequently the n output channels 13, 14 and 15 do not receive such low frequency signal components which a loudspeaker connected to the respective output channel would not be designed to handle and that consequently could lead to overload of the respective loudspeaker unit with a resultant degradation of sound quality due to the generation of non-linear distortion in the respective loudspeaker unit

To each of the n input channels there are furthermore connected a low-pass filter 8, 9, 10, respectively, and the respective output signals from each of these low-pass filters are connected to a summing bus (LFE Channel Mixing Bus) 12, such that the low frequency components from each of the n input channels after passage through the respective low-pass filters 8, 9, 10 are summed together on a single bus. Furthermore, the input signal on the LFE input channel 4 is provided to the summing bus (LFE Mixing Bus) 12 optionally after a suitable gain 11 has been provided to the LFE input signal.

The summed signal on the summing bus (LFE Channel Mixing Bus) 12 is provided to a suitable subwoofer 34 on output channel 16 of the system.

It is noted that although reference is made to a “summing bus” or a “LFE Channel Mixing Bus” throughout the present specification, other suitable summation means, such as a summing amplifier in an analogue implementation of the system and method according to the invention could also be used and such alternative implementations would also fall within the scope of the invention.

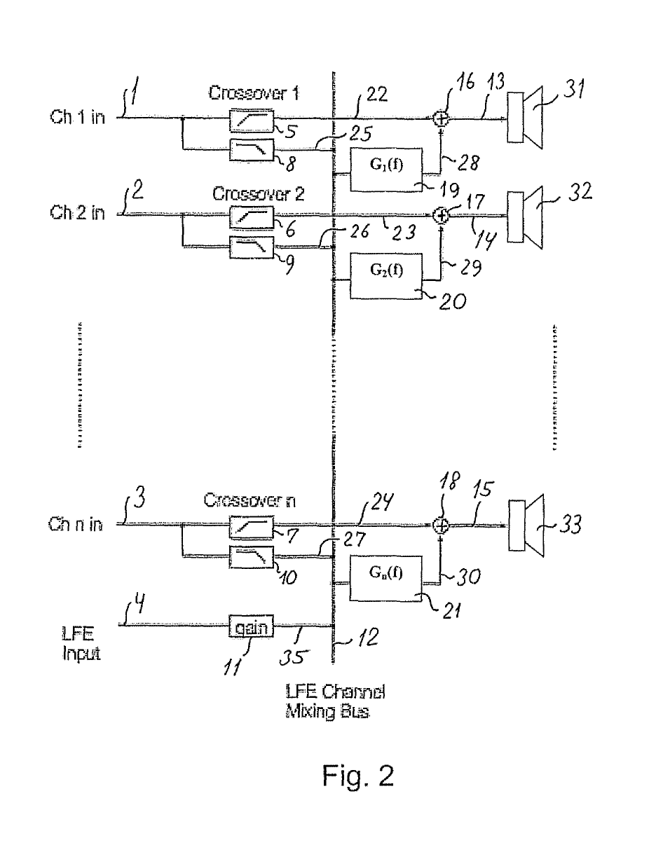

Referring to FIG. 2 there is shown one embodiment of a system according to the present invention. Components in FIG. 2 that are identical with components in FIG. 1 are designated by the same reference numerals. As in the prior art system shown in FIG. 1 signal components in each of the n separate input channels, reference numerals 1, 2 and 3, are divided by the high-pass filters 5, 6, 7 and the low-pass filters 8, 9, 10 in the crossover arrangements 1 through n into high frequency components provided on the outputs 22, 23, 24 of the respective high-pass filters 5, 6, 7 and low frequency components provided on the outputs 25, 26, 27 of the respective low-pass filters 8, 9, 10 The respective outputs from the low-pass filters are as in the prior art system shown in FIG. 1 provided to a LFE Channel Mixing Bus 12. The system according to the invention shown in FIG. 2 furthermore comprises adder units 16, 17, 18, providing the respective output signals for the respective output channels 13, 14, 15. The system according to the specific embodiment of the invention shown in FIG. 2 furthermore comprises gain or weighting units Gᵢ(f), G₂(f), Gₙ(f) (reference numerals 19, 20, 21) by means of which the summed low frequency signal on the summing bus (LFE Channel Mixing Bus) 12 can be individually processed (for instance amplified, attenuated, filtered, frequency-shaped or limited) prior to the provision to the respective adder units 16, 17, 18. Each respective adder unit 16, 17, 18 receives the output signal 22, 23, 24, respectively, from the corresponding high-pass filters 5, 6, 7 and the summed low-pass signal present on the summing bus (LFE Channel Mixing Bus) 12, after the processing carried out in each individual gain or weighting units G₁(f), G₂(f), Gₙ(f). Thus, each respective output channel 13, 14, 15 receives the high-pass signals components 22, 23, 24 from the corresponding input channel 1, 2, 3 and the summed (and suitably individually processed) low frequency signal from the summing bus (LFE Channel Mixing Bus 12).

1. A system for the reproduction of multichannel sound signals comprising:
a) n input channels (1, 2, 3) for receiving multichannel sound signals;
b) at least one input channel (4) for receiving a low frequency effects (LFE) signal;
c) n output channels (13, 14, 15) for providing signals from the system to respective transducers, such as loudspeakers (31, 32, 33);
d) for each of said input channels (1, 2, 3), high-pass filter means (5, 6, 7) receiving a signal from said respective input channel (1, 2, 3) and providing a corresponding high-pass filtered signal (22, 23, 24) to a respective second summing means (16, 17, 18);
e) for each of said input channels (1, 2, 3), low-pass filter means (8, 9, 10) receiving a signal from said respective input channel (1, 2, 3) and providing a corresponding low-pass filtered signal (25, 26, 27) to first summing means (12);
f) for said at least one input channel (4) for receiving a low frequency effects (LFE) signal gain means (11) receiving said low-frequency effects (LFE) signal and providing an output signal (35) to said first summing means (12);
g) for each of said output channels (13, 14, 15), LFE signal processing means (19, 20, 21) each receiving a signal from said first summing means (12) and each providing a processed output signal (28, 29, 30) to said respective second summing means (16, 17, 18);
h) each of said second summing means (16, 17, 18) having an output connected to each of said output channels (1.3, 14, 15);
whereby each of said output channels (13, 14, 15) provides processed output signals for each of said transducers, such as loudspeakers (31, 32, 33), respectively.

2. A system according to claim 1, wherein said LFE signals processing means (19, 20, 21) provides either frequency-independent gain or frequency-independent attenuation of said signal received from said first summing means (12).

3. A system according to claim 1, wherein said LFE signal processing means (19, 20, 21) is characterized by a frequency-dependent transfer function Gᵢ(f).

4. A system according to claim 1, wherein said LFE signal processing means (19, 20, 21) comprises limiter means for limiting the level of signals provided to the LFE signal processing means (19, 20, 21) from said first summing means (12).

5. A method for the reproduction of multichannel sound signals consisting of n input signals (1, 2, 3), at least one low frequency effects (LFE) signal (4) and n output signals (13, 14, 15);
the method comprising:
i. for each of said input signals providing a high-pass filtered signal (22, 23, 24);
ii. for each of said input signals providing a low-pass filtered signal (25, 26, 27);
iii. for each of said at least one low frequency effects (LFE) signals (4) processing these respective signals thereby providing respective amplified or attenuated low frequency effects (LFE) output signals (35), where said amplification or attenuation may specifically be equal to 1 (0 dB);
iv. summing in summing means (12) each of said low-pass filtered signals (25, 26, 27) and said at least one amplified or attenuated low frequency effects (LFE) output signals (35), whereby a summed signal is obtained;
v. providing each of said n output signals (13, 14, 15), such that each respective of the n output signals is obtained as a sum (16, 17, 18) of a respective signal of said high-pass filtered signal (22, 23, 24) and a processed version of said summed signal (12), where said processing is characterized by a transfer function Gi(f) (19, 20, 21), wherein i designates the particular output signal and where Gi(f) is either a frequency-independent gain or a frequency-independent attenuation, which gain or attenuation specifically can be equal to unity and/or where Gi(f) is a frequency-dependent transfer function and/or where Gi(f) comprises limiting of powerful signal components in said summed signal (12).
